(19) United States
(12) Patent Application Publication
(10) Pub. No.: US 2021/0157687 A1
(43) Pub. Date: May 27, 2021

(54) PERSISTENT MEMORY FILE SYSTEM WITHIN RECOVERABLE APPLICATION MEMORY WITHIN VOLATILE MEMORY

(71) Applicant: INTERNATIONAL BUSINESS MACHINES CORPORATION, Armonk, NY (US)

(72) Inventors: Michael Edward Drejza, Wallkill, NY (US); Michael J. Shershin, Poughkeepsie, NY (US); Christopher Daniel Filachek, Lagrangeville, NY (US); Mark Richard Gambino, Brewster, NY (US)

(21) Appl. No.: 16/695,677

(22) Filed: Nov. 26, 2019

(51) Int. Cl. G06F 11/14; G06F 9/4401; G06F 3/06

(52) U.S. Cl. CPC G06F 11/1471; G06F 9/4416; G06F 3/0631; G06F 3/0679; G06F 3/0619

(57) ABSTRACT

Aspects of the invention include a persistent memory file system within recoverable application memory within volatile memory. A non-limiting example computer-implemented method includes designating, by a processor, a portion of the system memory as recoverable application memory and establishing, by the processor, a portion of the recoverable application memory as a heap-backed memory file system. The computer-implemented method remounts, by the processor, the heap-backed memory file system following an initial program load. This heap-backed memory file system is available for general application use and for use as an internal caching mechanism for other cluster consistent file systems.

### BACKGROUND

The present invention generally relates to memory, and more specifically, to a persistent memory file system within recoverable application memory within volatile memory.

User application memory does not survive an initial program load (“IPL”). After an initial program load, memory must be reallocated and repopulated with data. For large areas of memory, this reallocation and repopulation can be costly in terms of I/O and CPU processing immediately after an initial program load.

### SUMMARY

Embodiments of the present invention are directed a persistent memory file system within recoverable application memory within volatile memory. A non-limiting example computer-implemented method includes designating, by a processor, a portion of the system memory as recoverable application memory and establishing, by the processor, a portion of the recoverable application memory as a heap-backed memory file system. The computer-implemented method remounts, by the processor, the heap-backed memory file system following an initial program load.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 illustrates a computer system in accordance with an embodiment;

FIG. 2 illustrates a block diagram of system memory in accordance with one or more embodiments of the present invention; and

FIG. 3 illustrates a flow chart of setting up a memory file system in accordance with one or more embodiments of the present invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describe having a communications path between two elements and do not imply a direct connection between the elements with no intervening elements/connections between them. All of these variations are considered a part of the specification.

### DETAILED DESCRIPTION

One or more embodiments of the present invention provide a recoverable application memory, which is an area of system memory that can be accessed by all processes and is usable by both system code and user application code. This allows users, as well as a recoverable memory file system, to have continued, uninterrupted access to the data stored in memory even after an initial program load. The recoverable memory file system utilizes the recoverable application memory described above to implement a recoverable memory file system that persists over an initial program load without being written to disk or to specialized non-volatile memory.

Memory file systems (“MFS”) are backed by memory rather than disk, as are most other file systems. Although this provides generally quicker operations within an MFS, when compared to disk backed file systems, the MFS does not persist over an initial program load. For this reason, the MFS can only be used to hold very transient data files such as temporary files, for example. This limits the significant performance benefits of the MFS to only a small subset of use cases compared to what a high performance persistent file system could provide.

One or more embodiments of the present invention address one or more of the above-described shortcomings of the prior art by providing an area of processor memory designated as recoverable across both planned an unplanned IPL's, where the hardware has not changed. This provides the ability to keep data in memory when a software initial program load occurs or when a hard initial program load without clear is done. The recoverable application memory is implemented within volatile memory and without specialized hardware. Volatile memory provides high speed access compared to non-volatile memory like flash memory. Using non-volatile memory to back an MFS is possible, but the access time to that MFS would be ten to one hundred times slower, thus not a high performance file system and thus defeating the purpose of using an MFS. The recoverable application memory is an area of system memory, specifically volatile random access memory (RAM) that can be accessed by all processes and is usable by both system code and user application code. This allows users, as well as a recoverable memory file system, to have continued, uninterrupted access to the data stored in memory even after an initial program load. The recoverable memory file system utilizes the recoverable application memory described above to implement a recoverable memory file system that persists over an initial program load without being written to disk or to specialized non-volatile memory.

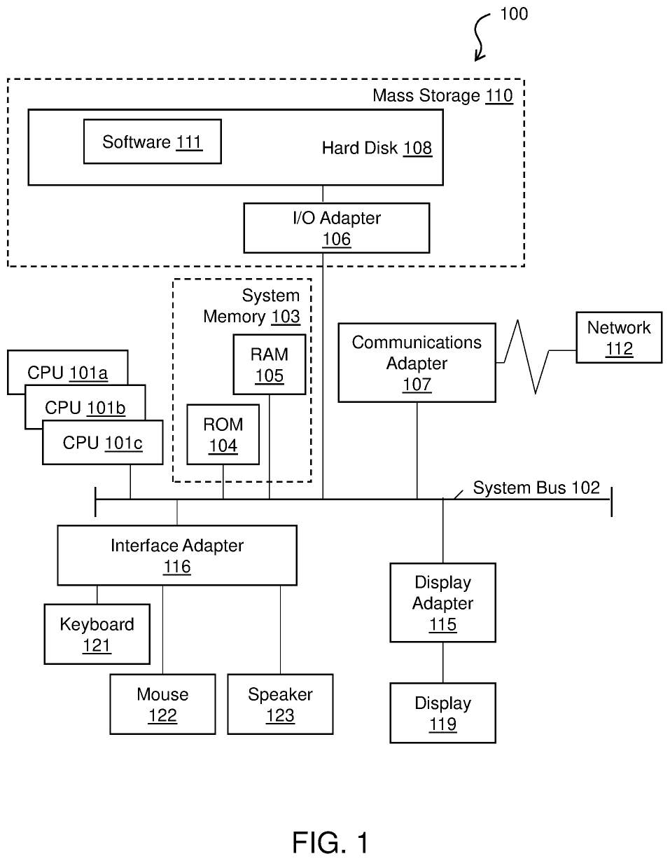

Turning now to FIG. 1, a computer system 100 is generally shown in accordance with an embodiment. As embodiments of the invention require no specialized hardware, a computer system in which embodiments are implemented will now be described. In embodiments, a portion of the processors 101 memory is designated as recoverable across planned and unplanned IPL's. This provides the ability to keep data in memory when a software initial program load occurs or when a hard initial program load without a clear is done. The computer system 100 can be an electronic computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc. (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system, such as the z/OS or AIX operating system from IBM Corporation, to coordinate the functions of the various components shown in FIG. 1.

Additional input/output devices are shown as connected to the system bus 102 via a display adapter 119 and an interface adapter 116 and. In one embodiment, the adapters 106, 107, 115, and 116 may be connected to one or more I/O busses that are connected to the system bus 102 via an intermediate bus bridge (not shown). A display 119 (e.g., a screen or a display monitor) is connected to the system bus 102 by a display adapter 115, which may include a graphics controller to improve the performance of graphics intensive applications and a video controller. A keyboard 121, a mouse 122, a speaker 123, etc. can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 1, the computer system 100 includes processing capability in the form of the processors 101, and, storage capability including the system memory 103 and the mass storage 110, input means such as the keyboard 121 and the mouse 122, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

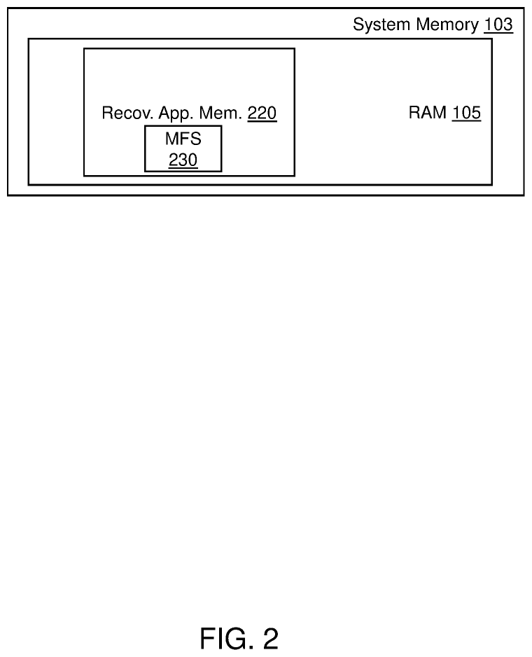

FIG. 2 illustrates a block diagram of system memory 103 in accordance with one or more embodiments of the present invention. System memory 103 is not specialized hardware, but rather is system memory that has a portion of RAM 105 designated as recoverable application memory 220. This provides the ability to keep data in memory when a software initial program load occurs or when a hard initial program load without clear is done. The recoverable application memory 220 is implemented within volatile memory and without specialized hardware. The recoverable application memory is an area of RAM 105 that can be accessed by all processes and is usable by both system code and user application code. This allows users, as well as the MFS, to have continued, uninterrupted access to the data stored in memory even after an initial program load. The memory file system 230 is stored in recoverable application memory 220.

A memory file system 230 that persists over an initial program load without being written to disk or to specialized non-volatile memory utilizes recoverable application memory 220 as its backing data store. The type of memory to use to back the MFS is specified when the MFS is created. After an initial program load occurs, the system attempts to remount previously mounted file systems. For a non-recoverable MFS, this involves creating a new MFS and logically mounting it (making it accessible). For a recoverable MFS, the system searches for the recoverable application memory 220 that was backing the MFS before the initial program load, using the recoverable application memory API and reuses it. This memory makes up the complete memory structure of the MFS as it existed before the initial program load, so the mount operation can simply attach it, rather than allocating new memory as is done for a non-recoverable MFS, to make it accessible for use.

Turning now to using the recoverable MFS as a cache, existing file system APIs will work with a recoverable MFS just as they do with a traditional non-recoverable MFS. For a non-MFS file system (meaning one that is backed by persistent storage), MFS is used as a read-only cache copy of that persistent file system that is transparent to the application. In other words, the application mounts the persistent file system and the operating system creates an internal use MFS to cache highly accessed files in that file system. Whenever an application reads from that file system, the internal MFS is checked first to see if there is a cached copy of the file already in memory that is still valid, and if so, uses it. This internal use MFS being backed by recoverable memory means the cache is intact even after an IPL.

Similar to a write-through cache mechanism, this on-demand synchronization of the MFS is always consistent. Distinct from a write-through cache mechanism, the cached copy is synchronized during the read operation rather during the write operation. For this reason, this on-demand synchronization method benefits read dominate (rarely changed), as opposed to write dominate (frequently changed), use cases.

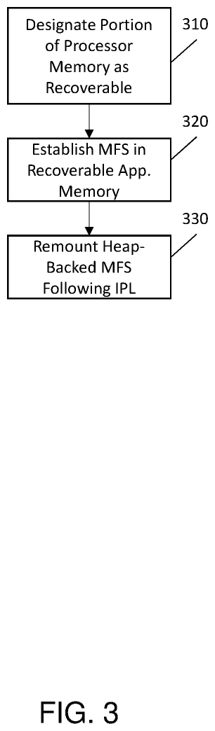

FIG. 3 illustrates a flow chart of setting up a persistent memory file system in accordance with one or more embodiments of the present invention. A portion of RAM 105 is designated a recoverable application memory 220 at block 310. The recoverable application memory 220 is implemented without specialized hardware within, for example, volatile 64-bit memory accessible by all processes, called system heap. The data in the recoverable application memory 220 is not lost when the system IPL's unless a processor or memory configuration change is made or unless an IPL with clear is done. The recoverable application memory 220 is permanently backed by physical frames rather than on an “as needed” basis. The size of the recoverable application memory 220 is part of the memory configuration for the system. If the size of the recoverable application memory 220 changes in the memory configuration, the recoverable application memory 220 area will not be recovered and data in the recoverable application memory 220 area will be lost. An application program interface (“API”) provides the user with the ability to allocate, release, and find a piece of recoverable application memory 220. The system provides each allocated piece of recoverable application memory 220 a unique token via this API. The token is used to locate a particular piece of allocated memory after an initial program load via this API. On a recoverable application memory allocation request, there is an option to allocate non-recoverable memory instead of recoverable memory if the request for recoverable memory cannot be satisfied. There is also the ability to group multiple pieces of recoverable application memory under one unique token. Although there are multiple non-contiguous pieces of memory, this grouping allows all of it to be located or released with a single API call. Various APIs and commands used to manage and monitor memory on the system are updated to incorporate the recoverable application memory feature set.

A heap-backed memory file system 230 is established in the recoverable application memory in block 320. In block 330, the heap-backed memory file system 230 is remounted following an IPL without having to be rebuilt.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
designating, by a processor, a portion of system memory as recoverable application memory;
establishing, by the processor, a portion of the recoverable application memory as a heap-backed memory file system; and
remounting, by the processor, the heap-backed memory file system following an initial program load (“IPL”).

2. The computer-implemented method of claim 1, wherein designating, by the processor, a portion of the system memory as recoverable application memory comprises providing, by the processor, an allocated piece of recoverable application memory a unique token.

3. The computer-implemented method of claim 2, wherein a plurality of allocated pieces of recoverable application memory are provided the same unique token.

4. The computer-implemented method of claim 1, wherein remounting, by the processor, the heap-backed memory file system following an initial program load comprises searching the recoverable application memory, finding the heap-backed memory file system, and reusing the heap-backed memory file system.

5. The computer-implemented method of claim 1, wherein the heap-backed memory file system comprises a persistent file system and an internal use memory file system that resides within recoverable application memory.

6. The computer-implemented method of claim 1, wherein the memory file system has persistent characteristics.

7. The computer-implemented method of claim 6, further comprising using the heap-backed memory file system as a read only cache for cluster consistent files residing in the heap-backed memory file system.

8. A system comprising:
a memory having computer readable instructions; and
one or more processors for executing the computer readable instructions, the computer readable instructions controlling the one or more processors to perform operations comprising:
designating a portion of system memory as recoverable application memory;
establishing a portion of the recoverable application memory as a heap-backed memory file system; and
remounting the heap-backed memory file system following an initial program load (“IPL”).

9. The system of claim 8, wherein designating a portion of the system memory as recoverable application memory comprises providing, by the processor, an allocated piece of recoverable application memory a unique token.

10. The system of claim 9, wherein a plurality of allocated pieces of recoverable application memory are provided the same unique token.

11. The system of claim 8, wherein remounting the heap-backed memory file system following an initial program load comprises searching the recoverable application memory, finding the heap-backed memory file system, and reusing the heap-backed memory file system.

12. The system of claim 8, wherein the heap-backed memory file system comprises a persistent file system and an internal use memory file system that resides within recoverable application memory.

13. The system of claim 8, wherein the memory file system has persistent characteristics.

14. The system of claim 13, further comprising using the heap-backed memory file system as a read only cache for files residing in another cluster consistent file system.

15. A computer program product comprising a computer readable storage medium having program instructions embodied therewith, the program instructions executable by a processor to cause the processor to perform operations comprising:
designating a portion of system memory as recoverable application memory;
establishing a portion of the recoverable application memory as a heap-backed memory file system; and
remounting the heap-backed memory file system following an initial program load (“IPL”).

16. The computer program product of claim 15, wherein designating a portion of the system memory as recoverable application memory comprises providing, by the processor, an allocated piece of recoverable application memory a unique token.

17. The computer program product of claim 16, wherein a plurality of allocated pieces of recoverable application memory are provided the same unique token.

18. The computer program product of claim 15, wherein remounting the heap-backed memory file system following an initial program load comprises searching the recoverable application memory, finding the heap-backed memory file system, and reusing the heap-backed memory file system.

19. The computer program product of claim 15, wherein the heap-backed memory file system comprises a persistent file system and an internal use memory file system that resides within recoverable application memory.

20. The computer program product of claim 15, wherein the memory file system has persistent characteristics.
